(19) United States
(12) Patent Application Publication
(10) Pub. No.: US 2006/0006199 A1
(43) Pub. Date: Jan. 12, 2006

(54) Portable ice cream dispenser

(76) Inventor: In Jae Shin, Seoul (KR)

Correspondence Address: PARK & SUTTON LLP, 3255 WILSHIRE BLVD, SUITE 1110, LOS ANGELES, CA, 90010, US

(21) Appl. No.: 10/526,790

(22) PCT Filed: Apr. 25, 2003
(86) PCT No.: PCT/KR03/00843

§ 371 Date: Mar. 7, 2005

(30) Foreign Application Priority Data
Nov. 15, 2002 (KR) 20-2002-0034186

(51) Int. Cl. B67D 5/42; G01F 11/00

(52) U.S. Cl. 222/390

(57) ABSTRACT

According to the distribution device, portable ice cream distribution device never shown on earlier technique is provided and due to this soft ice cream can be stored so that with out any power supply storing, carrying and selling of soft ice cream in outdoor such as park and stadiums. And since it has simple composition and does not need high technology, the production cost is cheap and can be minimized and so it maximizes selling.

### BACKGROUND OF THE INVENTION

1. Field of the Invention

This present invention refers to portable ice cream distributor discharging certain amount of ice cream stored in container with either automatic or manual operation for storing and distributing specially soft ice cream.

2. Description of the Prior Art

In general, the ice cream most of the people enjoy is classified usually as hard type and soft type. In case of hard type, it can be sold by scooping ice cream with spoon from freezer to cone cup or in already-wrapped type where it is saved in minimized icebox. In case of soft type, unless it is stored in freezer it easily melts in air and so it is hard to sell it in portable situation.

Besides, for freezer where soft ice cream is stored to maintain adequate temperature, continuous electricity source should be supplied for activation of freezer device so that it has difficulties selling outdoors such as theme park or stadium.

And also, in case of soft ice cream, when it is stored in container such as icebox it cannot supply tornado-type ice cream since it does not have special discharge device and even if there is one, electricity source for this discharge device is necessary.

Due to all these reasons mentioned above, soft ice cream is hardly sold outdoor and less people could enjoy this ice ream and cannot maximize the sale.

### SUMMARY OF THE INVENTION

This invention refers to portable ice cream distributor containing part storing ice cream and part storing ice or dry ice for preventing ice cream from melting and has special feature such as activation device automatically or manually operated to discharge certain amount of ice cream and discharge device. In addition case keeping the cups for ice cream, portable carrier and shoulder strap can be attached.

### BRIEF DESCRIPTION OF THE DRAWINGS

The aforementioned aspects and other features of the present invention will be explained in the following description, taken in conjunction with the accompanying drawings, wherein:

FIG. 1 shows perspective view of assembling distribution device based on examples of present invention.

FIG. 2 shows front view of a side of distribution device based on examples of present invention.

FIG. 3 shows front view of a side of distribution device based on other examples of present invention.

FIG. 4 shows conceptual view of example of commercial use of distribution device based on examples of this invention.

### DESCRIPTION OF MAIN PARTS OF FIGURES

10: Container
12: Partition Board
20: Cover
30: Activation Device
31: Lever
32: Activation Shaft
33: Screw Groove
34: Activation Plate
40: Discharge Device
41: Discharge Pipe
43: Tube
45: Discharge Outlet

### DETAILED DESCRIPTION OF PREFERRED EMBODIMENTS

The present invention will be described in detail by way of a preferred embodiment with reference to accompanying drawings.

Technological Objective of Invention

This present invention was created to solve all those problems mentioned above and the purpose is to provide portable distribution device which soft ice cream can be stored.

Another purpose of this invention is to maximize the sale of soft ice cream by providing discharge device which can store soft ice cream without electricity source and which is easy to produce in cheap cost.

For achieving the goal this portable ice cream distributor contains part storing ice cream and part storing ice or dry ice for preventing ice cream from melting and has special feature such as activation device automatically or manually operated to discharge certain amount of ice cream and discharge device.

Activation device is designed in mechanical activation principal which does not require power supply and motor running by recharged battery for automatic activation (switch select) can be equipped. This design is equipped with minimized device and simplification of composition. Detailed descriptions on figures showing experimental examples of this present invention are followed.

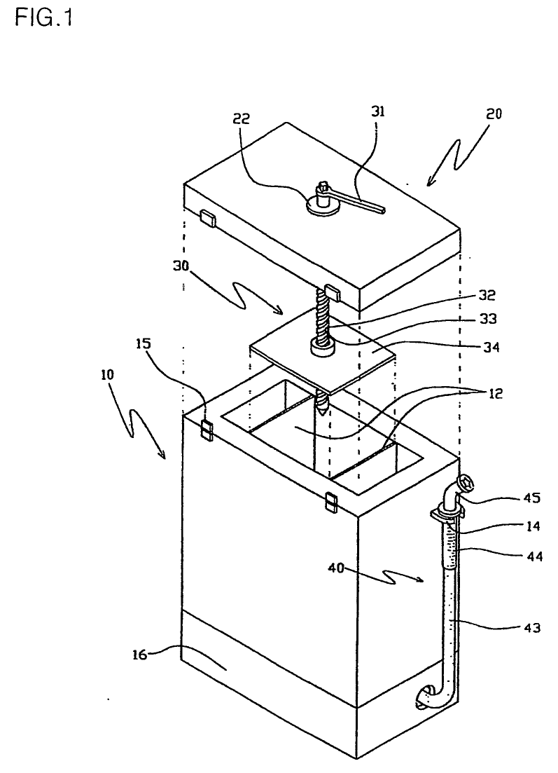

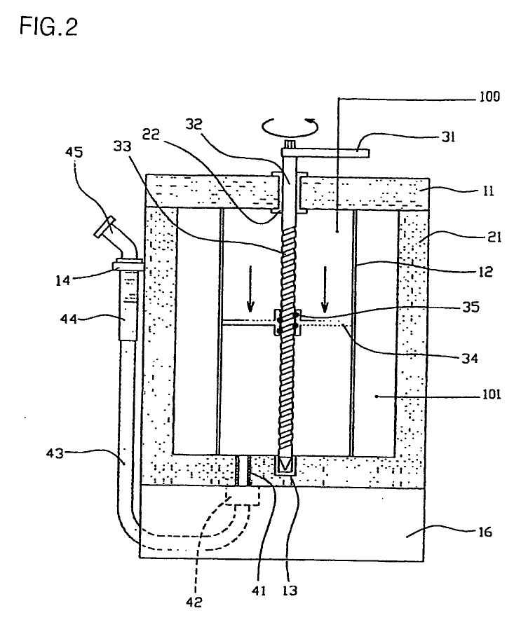

FIG. 1 is a composition perspective view of distribution device based on example of this invention and FIG. 2 is front view showing a part of distribution device. As it is shown, the cover (20) dischargeable from the container (10) is equipped with adiabatic element (11)(21) and the container and cover can be opened/closed using hinge (15) as shown on FIG. 1.

Inside of container (10) is divided into central part (100) and 2 side part (101) close to this central part by partition board (12) and soft ice cream is stored in the central part (100) while cooling elements such as dry ice or ice are stored in the side part (101).

In the middle of cover mentioned above, packing (22) is made to form a hole and through this hole of packing (22), activation axis (32) one of activation device (30) penetrates through and bottom hem of this activation axis (32) is fixed on groove (13) which makes the axis rotate. Rotation of activation axis (32) is operated manually be lever (31) made on upper hem and on outer side of this activation axis, screw groove (33) is formed. Activation plate (34), contacted with screw groove (33) can be ascent or descent with rotation. Combination of activation plate (34) and activation axis can be connected with screw groove (33) around central part of activation plate and axis with ball in the center of activation plate such as ball bearing (35) is combined in one form and with settlement of this ball to screw groove (33) ascent or descent by rotation can be amicable.

And also, the activation plate should be at least in same size or smaller to minimize the amount of ice cream stored in lower part of activation plate (34) leaking into upper part. On a part of bottom side of the container (10) discharge pipe (41) one of discharge devices (40) forms a hole and prescribed length of tube with flexibility is connected with the discharge pipe (41) by connection part (42).

Knob (44) is equipped on a prescribed location of tube (43) has discharge outlet (45) on the other hem of connection part and this discharge outlet (45) is formed in star shape to discharge ice cream in tornado shape and by producing the tube (43) with adiabatic element it prevents ice cream in the tube from melting.

Meanwhile, on a prescribed part of outer side of container, hanger part (14) is equipped so that tube is not carried while moving one place to another and it prevents ice cream from discharging eventually.

Operation of distribution device is described based on example as followed. As it is mentioned earlier, in the central part, soft ice cream is stored and dry ice or ice is stored on a side part and with container (10) closed with cover (20) it maintains ice cream in freeze condition with freeze element cutting the temperature of outside with adiabatic substance.

When to discharge ice cream stored, by rotating lever (31) to a side, activation axis rotates and so activation plate (34) descent and press ice cream which is discharged through discharge pipe (41), tube (43) and discharge outlet (45).

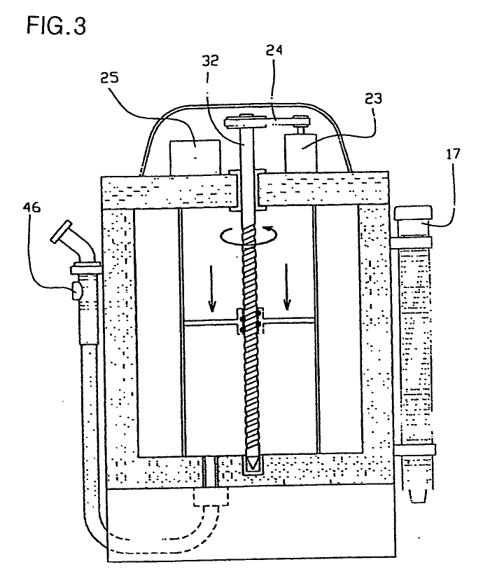

FIG. 3 is a front view showing a part of discharge device based on example of this present invention and important symbols of immediate constituent repeated is not mentioned and as it is shown on figure, activation axis (32) can rotate automatically with motor (23). Motor (23) can be any part of upper portion of cover and rotation axis and activation axis of motor is connected to belt (24) and motor (23) rotates by rechargeable battery (25) and device is controlled with switch (46) place on the knob (44).

For automatic distribution device, considering this invention is portable, the weight of motor battery increases and so diverse technique to minimize all those devices can be applied.

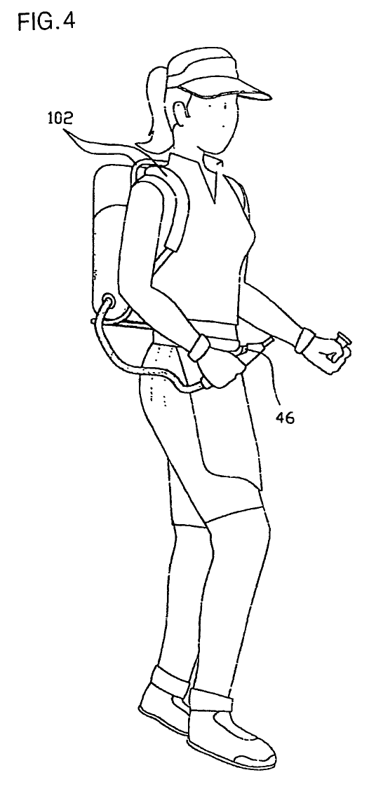

FIG. 4 is a conceptual view of example of this discharge device in commercial use and as it is shown in the figure, carrier device (102) such as should strap can be used for convenience of movement and as it is shown on FIG. 1 or 3, support (102) to place the device on the ground cab be added in several types. As it is shown on FIG. 3, by adding case (17) holding cone cups, since the seller can hold the knob and cone cup at the same time, it is much more convenient.

As in conceptual view in FIG. 4, discharge device of this invention can change its design with modern sense, and also frozen yogert can be stored or distributed too. This invention is described in detail however it can go through any changes or improvements in range of not running counter to essence spirit and aspect of this invention

What is claimed is:

1. For device distributing storing ice cream,
Portable ice cream distribution device has central part (100) and side part (101) divided by partition board (12) and outside is made with adiabatic substances. It is composed with container (10) with grooved on the inner center, cover made of adiabatic substance with packing forming hole in the middle,
activation device (30) with lever (31) fixed on upper side of activation axis (32) mentioned earlier and with hem of activation axis (32) penetrating the packing and activation plate (34) placed on screw groove (33) formed outside,
and combination of discharge devices such as discharge pipe (41) forming hole on prescribed part of bottom side of container and tube (43) with knob (44) connected to the discharge pipe and finally discharge outlet (45) on the hem.

2. In claim 1,
Portable ice cream distribution device which has motor on prescribed portion of cover replacing lever mentioned above and battery running this motor and device which is equipped with switch on the knob controlling rotation of motor and which the rotation of motor transmits to activation axis (32).

3. In claim 1 or 2,
Portable ice cream distribution device which has special feature of rotating ball bearing (35) placed on screw groove on the center of activation plate.

4. In claim 3,
Portable ice cream distribution device with additional device such as hanger part (14) fixing the tube on a side of outer portion of container or case (17) holding the cone cup.

5. In claim 4,
Portable ice cream distribution device with addition device such as strap (102) to hold the device on body or support (16) to put the device on ground.
